(19) United States
(12) Patent Application Publication
(10) Pub. No.: US 2004/0030633 A1
(43) Pub. Date: Feb. 12, 2004

(54) Systems and methods for school districts and municipalities to maximize interest earnings on their investments

(76) Inventor: Austin T. Gavin, Stony Brook, NY (US)

Correspondence Address: Galgano & Burke, Suite 35, 300 Rabro Drive, Hauppauge, NY, 11788, US

(21) Appl. No.: 10/631,282

(22) Filed: Jul. 31, 2003

Related U.S. Application Data
(60) Provisional application No. 60/400,636, filed on Jul. 31, 2002.

(51) Int. Cl. G06F 17/60

(52) U.S. Cl. 705/37

(57) ABSTRACT

Systems and methods by which an investor can solicit bids from banks and/or financial institutions to obtain the best rate of return on an investment. According to the presently preferred embodiment, these methods are implemented via a computing and telecommunications system, e.g. a secure server coupled to the Internet.

This application claims the benefit of provisional application serial No. 60/400,636 filed Jul. 31, 2002, the complete disclosure of which is incorporated herein by reference.

### BACKGROUND OF THE INVENTION

1. Field of the Invention

The invention relates to an electronic bidding system. More particularly, the invention relates to a system for enabling an investor, especially a municipal investor, i.e., a school district or a municipality, to obtain the best rate of return on a short term cash investment.

2. State of the Art

Due to the manner in which school districts and municipalities and other private and public organizations acquire and disburse funds, they often possess relatively large quantities of cash for relatively short periods. It is the fiduciary responsibility of these entities to invest idle cash, thereby providing tax relief to local residents. Indeed many states require that municipalities invest idle cash in safe fixed rate instruments such as U.S. Treasury Bills, insured certificates of deposit, etc.

Although there are many types of electronic financial bidding systems available to consumers as well as sophisticated investors, none of them addresses the specific needs of school districts and municipalities and other private/public organizations. For example, U.S. Pat. No. 5,905,974 to Fraser et al. discloses an automated auction processor which includes transaction management of auction-based income instruments, such as T-bills, using a linked computer processing system, such as ETHERNET, LAN, WAN, etc. The system is generally designed to assist the sellers of income instruments which have traditionally been sold at auction. It is not designed to assist an investor in obtaining the best short term rate of return for a relatively large cash investment.

U.S. Pat. No. 5,915,209 to Lawrence discloses a computer implemented, online bond trading system which includes a selling trader placing the bond in a database that can be accessed by a plurality of bidding traders such that the bonds are held at auction for a predetermined period of time for the bidders, after which the highest bidder receives the bond. Clearly, this system works against the interests of the bond purchaser and favors the bond seller.

U.S. Pat. No. 5,966,699 to Zandi discloses a system and method for conducting an electronic loan auction over a computer network, such as the Internet, which includes receiving a loan application from a borrower which is posted in a database, the database available to various lenders which may submit bids for the loan during a preset period of time, i.e., the length of the auction time. This system also works against the interest of the investor (lender) to obtain the lowest rate of return thereby benefitting the borrower.

U.S. Pat. No. 6,161,099 to Harrington discloses a system for auctioning municipal bonds. This is, of course, quite the opposite of the situation addressed by the present invention. Harrington is concerned with the situation where a municipality needs to borrow money, usually over a long term. The present invention is concerned with the situation where a municipality needs to invest money, usually over a short term.

U.S. Pat. No. 6,397,197 to Gindlesperger discloses a system and method for competitive bid selection from a plurality of print and other customized information product vendors based on a database of vendor records. This is indeed a very specialized type of bidding system.

U.S. Pat. No. 6,438,526 to Dykes discloses an automated system for collecting and disseminating loan information over a network connection includes a server which receives loan data, including daily loan data, from lenders and stores the loan data in a database. A web server provides to users (e.g., brokers, correspondents, or retain loan customers) interactive web content including load information and a list of load criteria which would affect the quoted points, rate, cap, or margin associated with a particular loan. The web server receives a user's applicable loan criteria selected from the list of possible loan criteria and uses that applicable loan criteria and the loan data from the lender to create a list of adjustments to the points, rate, cap or margin. A quoted interest rate and the list of applicable adjustments are transmitted by the web server to the user. As with many of the known electronic financial bidding systems, this system is aimed at getting the lowest interest rate for a borrower.

Published U.S. patent application Ser. No. 20020169708 to Chittenden discloses a method for competitively sealed bidding on debt obligations over a computer network. The data associated with a debt obligation desired by a borrower includes a bid due date. The data associated with a bid includes a rate of the debt obligation by a lender to underwrite the debt obligation desired by the borrower. This is yet another system aimed at getting the lowest interest rate for a borrower.

Published U.S. patent application Ser. No. 20020138421 to Monlux discloses an on-line financing application service (FAS) equipped with functionalities to enable multiple funding sources to create multiple financing program offerings on-line. The FAS also facilitates the funding sources to selectively associate selected ones of the financing program offerings to multiple brokers/vendors, who in turn may create derivative financing program offerings, apply for financing, apply on behalf of their clients, or facilitate direct application by their clients, under selected ones of the financing program offerings on-line. The FAS is also equipped to allow an application submitted for consideration under a financing program offering to be automatically approved or referred to another rate sheet for quoting another financing program offering of the same/different funding source/broker for consideration. In one embodiment, the automatic approval or referral is based at least in part on the business profile and credit information of the applicant. Although somewhat more sophisticated than many of the other systems, this system is still aimed towards getting the lowest interest rate for a borrower.

Published U.S. patent application Ser. No. 20020077955 to Ramm discloses a full maturity option bond fund that provides a bond fund wherein the investors have the option of specifying maturity dates for their investment that coincide with the maturity data of debt securities held by the bond fund manager. Like the bond fund systems described above, this system assists municipalities seeking to borrow money rather than to invest it.

Published U.S. patent application Ser. No. 20020029188 to Schmid discloses a method and apparatus to facilitate competitive financial activities among myriad lenders on behalf of one borrower which includes the use of an online system that transmits information to lenders regarding the loan request from which bids are received. The bids are posted to an electronic database from which the borrower may view and select that loan that best fits their needs. This is still another method for obtaining the lowest possible interest rate for a borrower.

Published U.S. patent application Ser. No. 2002002640 to Hueler discloses a system and method for facilitating electronic bidding between stable value fund managers and stable value contract issuers. A fund manager creates an electronic bid invitation, and identifies the contract issuers from whom a responsive bid is desired. The electronic bid invitation is electronically dispatched to the designated issuers in order to prompt the issuers to furnish the bid. Electronic bid responses are submitted by the designated issuers back to the manager in response to the electronic bid invitations. The manager identifies the best bid response from all of the bid responses received. The issuer who submitted the most favorable bid response is notified through an electronic transmission that the manager would like to enter into an investment contract with that issuer, at terms substantially defined in the seller's winning bid response.

From the foregoing, it can be appreciated that many different types of electronic financial bidding systems have been patented and proposed. It will also be appreciated that most of the patents and published applications are directed toward servicing debtors, i.e. allowing borrowers to find the lowest interest rate for a loan. Only two of the documents described above (Hueler and Ramm) are specifically related to servicing investors. However, the Hueler disclosure is very technical and relates to very esoteric financial transactions among fund managers and contract issuers. The Ramm disclosure is specifically limited to bond funds.

None of the documents described above discloses or suggests a system for allowing an investor especially a municipal investor to obtain the best rate of return on a short term cast investment.

### SUMMARY OF THE INVENTION

It is therefore an object of the invention to provide a method by which an investor may solicit bids from banks and/or financial institutions to obtain the best rate of return on an investment.

It is also an object of the invention to provide such a method which is well suited for short term investments.

It is another object of the invention to provide such a method which is well suited for investors such as school districts, municipalities and other private and public organizations.

It is still another object of the invention to provide such a method which is implemented via computer and telecommunications apparatus.

In accord with these objects which will be discussed in detail below, the methods of the present invention include providing means by which an investor can solicit bids from banks and/or financial institutions (hereinafter “investees” or “bidders”) to obtain the best rate of return on an investment. According to the presently preferred embodiment, these methods are implemented via a computing and telecommunications system, e.g. a secure server coupled to the internet. Exemplary methods according to the invention permit an investor to submit an investment for bid, to review bids submitted, and to select the desired bidder with whom to make the investment. These exemplary methods also permit bidders to review the investments available for bidding and to submit bids for the desired investments. The systems of the invention also include portfolio management features for the investors such as providing wire transfer notices, reporting of existing investments, past investments, and pending investments subject to bidding. For the bidders, the systems of the invention permit review of pending auctions, the placement of bids, review of auction results, review of future auctions, review of previous auction results and review of investment history.

Additional objects and advantages of the invention will become apparent to those skilled in the art upon reference to the detailed description taken in conjunction with the provided figures.

### BRIEF DESCRIPTION OF THE DRAWINGS

FIG. 1 is a screen shot of a main menu for investors in a system according to the invention;

FIG. 2 is a screen shot of the data entry screen for entering an investment;

FIG. 3 is a screen shot of a preview/confirmation;

FIG. 4 is a screen shot of a main menu for bidders in a system according to the invention;

FIG. 5 is a screen shot of a listing of upcoming auctions;

FIG. 6 is a screen shot of a bidding selection;

FIG. 7 is screen shot of a bidding entry;

FIG. 8 is a screen shot of a bidding entry and investment detail view;

FIG. 9 is a screen shot of a bidding entry and bid ranking view;

FIG. 10 is a screen shot of a bid acceptance/award list;

FIG. 11 is a screen shot of the investment award entry screen; and

FIG. 12 is a screen shot of the award notice transmit screen.

### BRIEF DESCRIPTION OF THE APPENDIX

The attached CD/ROM appendix is incorporated herein by reference. The CD-ROM includes all of the source code for the system of the invention in a single text file (size-450 KB; created 2002)

### DETAILED DESCRIPTION OF THE PREFERRED EMBODIMENTS

According to the presently preferred embodiment, the methods of the invention are implemented via a computing and telecommunications system, e.g. a secure server coupled to the internet. Participants include investors and bidders. In order to use the system, participants must register a username and a password in a conventional way. There may be a fee charged for registration and/or a commission may be charged for each successfully completed transaction. According to the presently implemented embodiment, separate login fields are provided for investors versus bidders. However, the system could be implemented to automatically distinguish between the two types of users based on the username registry.

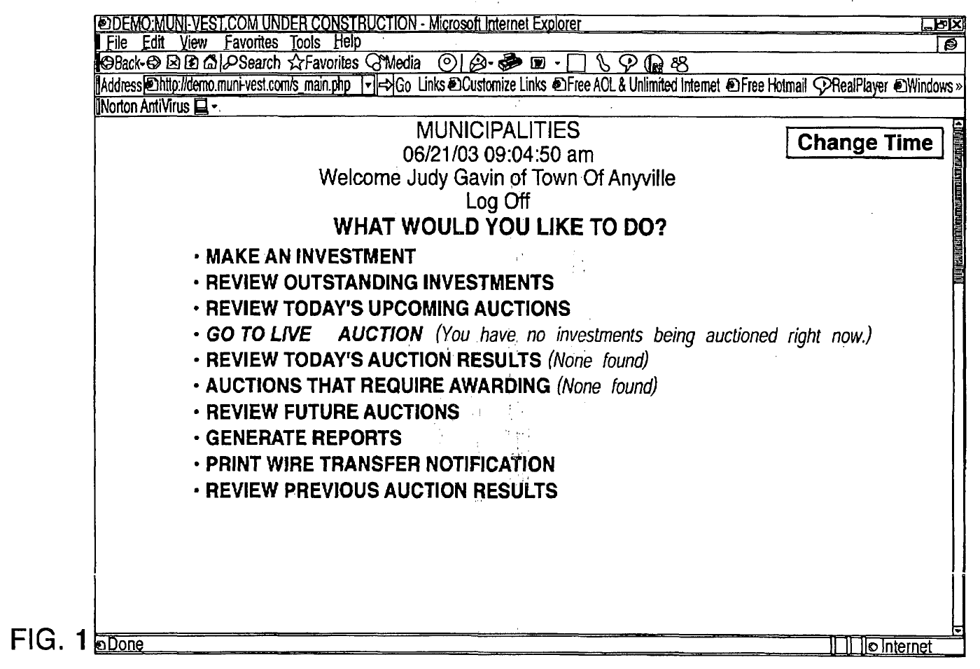

Turning now to FIG. 1, when an investor logs onto the system, a menu of options such as that shown in FIG. 1 is presented. The user may select to: make an investment, review outstanding investments, go to a live auction, review today's auction results, and view auctions that require awarding. It should be noted that according to the presently preferred embodiment, the number of results available for a particular choice is indicated in parentheses to the right of the menu item. In addition to these action items, the menu shown in FIG. 1 also provides options such as: review future auctions, generate reports, print wire transfer notification, and review previous auction results.

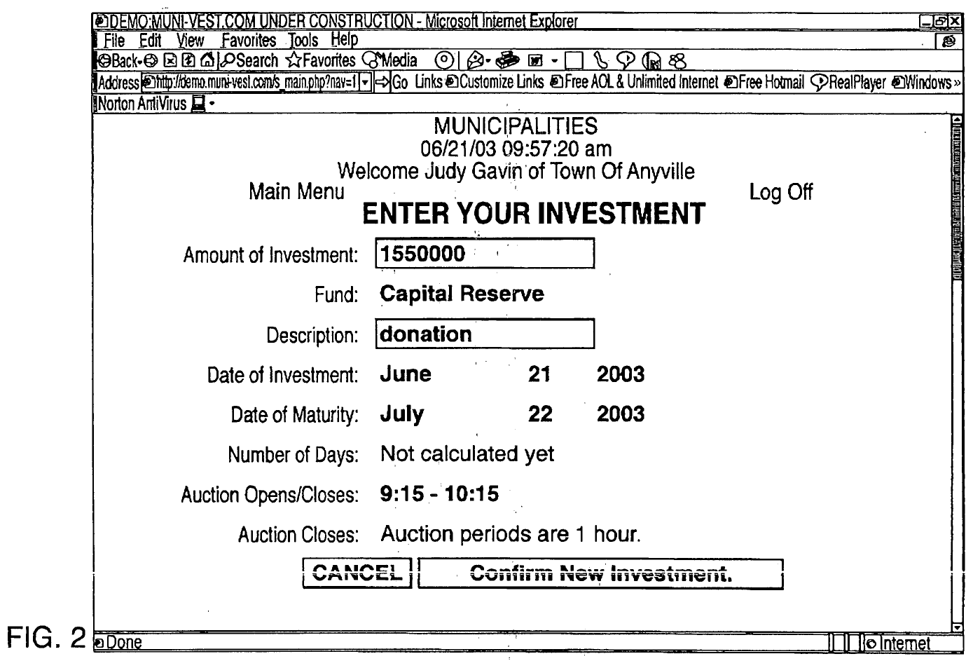

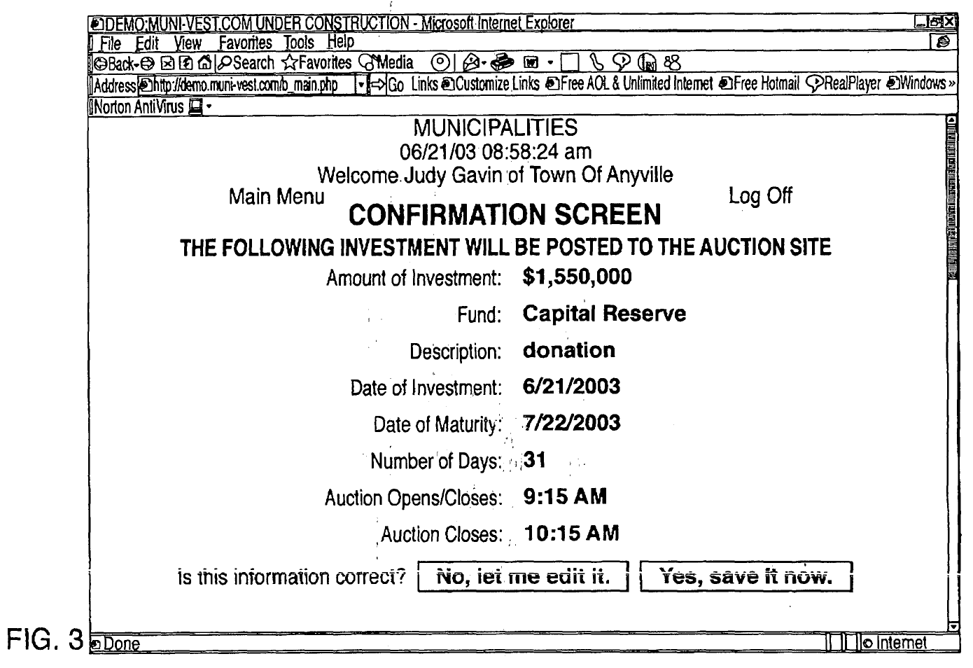

When a user selects “make an investment” from the menu of FIG. 1, a data entry screen such as the one shown in FIG. 2 is displayed. The data entry screen has several data fields; some are drop down menus. As shown in FIG. 2, the data entry fields include: the amount of the investment, choice of fund from which the money will be drawn, description of the fund/investment, date of investment, date of maturity, and when the auction opens/closes. Two pushbutton options are to “cancel” or to “confirm” the new investment. By choosing to confirm the investment, a screen such as that shown in FIG. 3 is displayed. This screen contains all of the information entered in the previous data entry form plus a calculated display of the number of days between investment and maturity. Two pushbutton options are “no, let me edit it” and “yes, save it now”. Choosing the “edit it” button returns to the screen shown in FIG. 2. Choosing the “save it” button, will post the information to the auction list and allow the receipt of bids. The information posted will be available only to bidders. Investors will not be able to view the investments of each other.

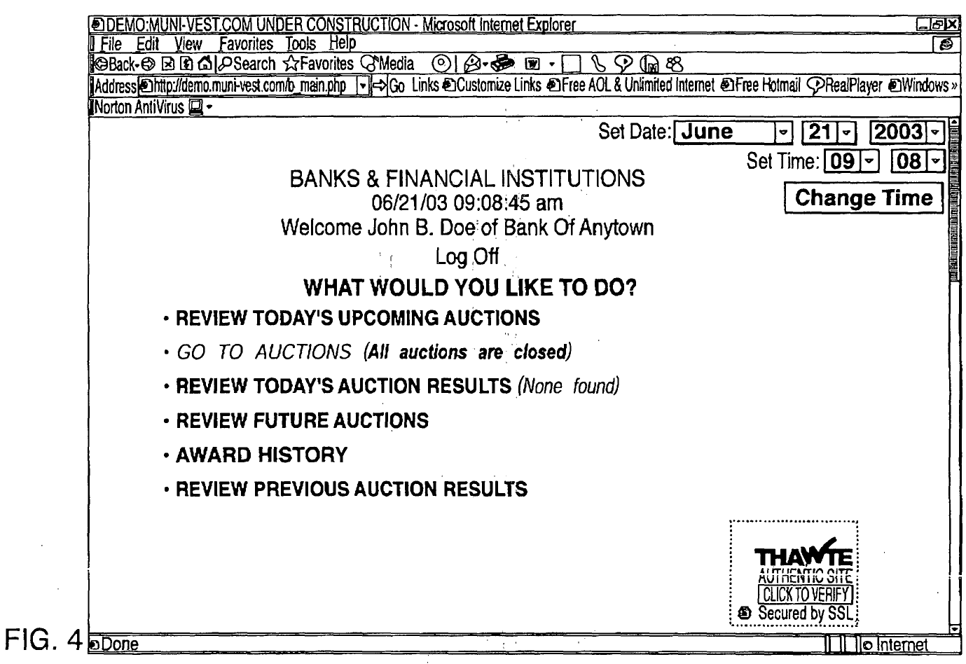

When an investee logs onto the system, a menu such as that shown in FIG. 4 is displayed. It will be appreciated that the options are different from those presented to investors. Exemplary options available to bidders include: review today's upcoming auctions, go to auctions, review today's auction results, review future auctions, view your award history, and review previous auction results. The number of items to be returned for each menu choice is preferably indicated in parentheses to the right of the menu item.

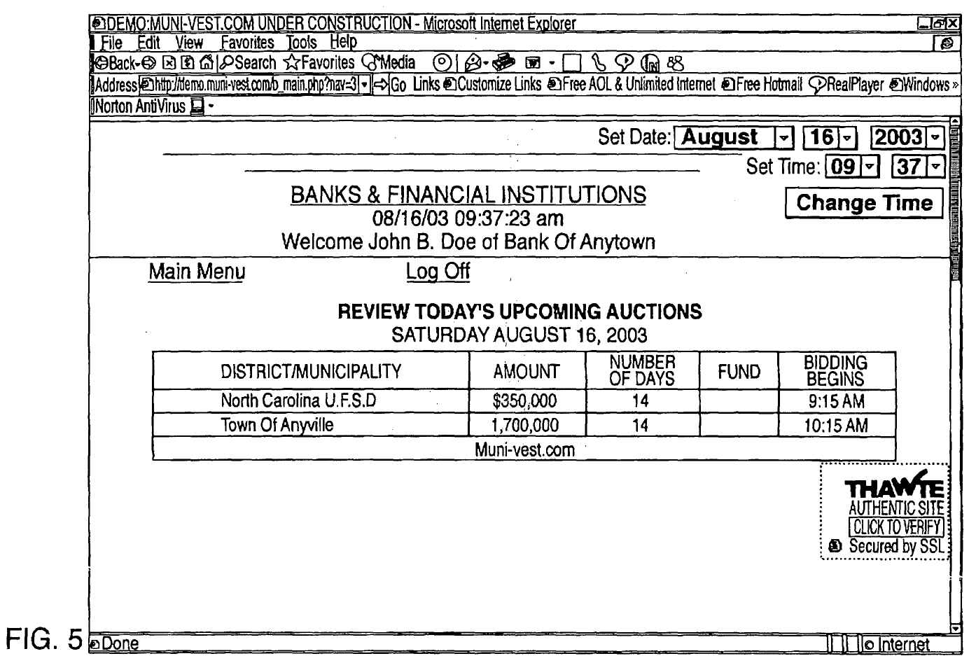

If the investee chooses to “review today's upcoming auctions”, a screen such as that shown in FIG. 5 is displayed. The list of auctions lists the name of the investor, the investment amount, the length of the investment in days, the fund, and the time bidding begins. No action can be taken from this screen (other than return to main menu); it is for information only.

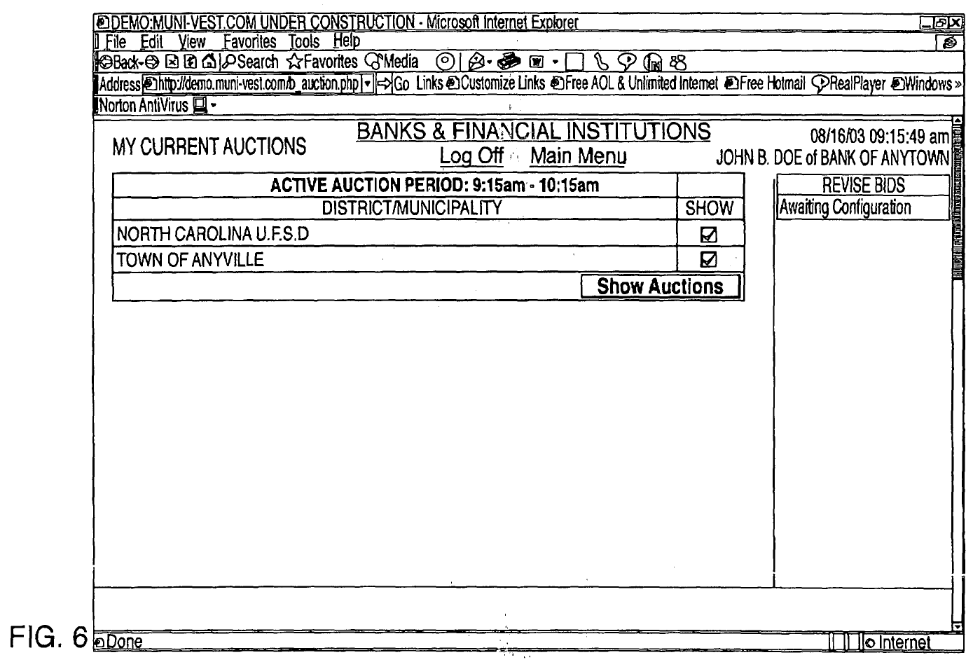

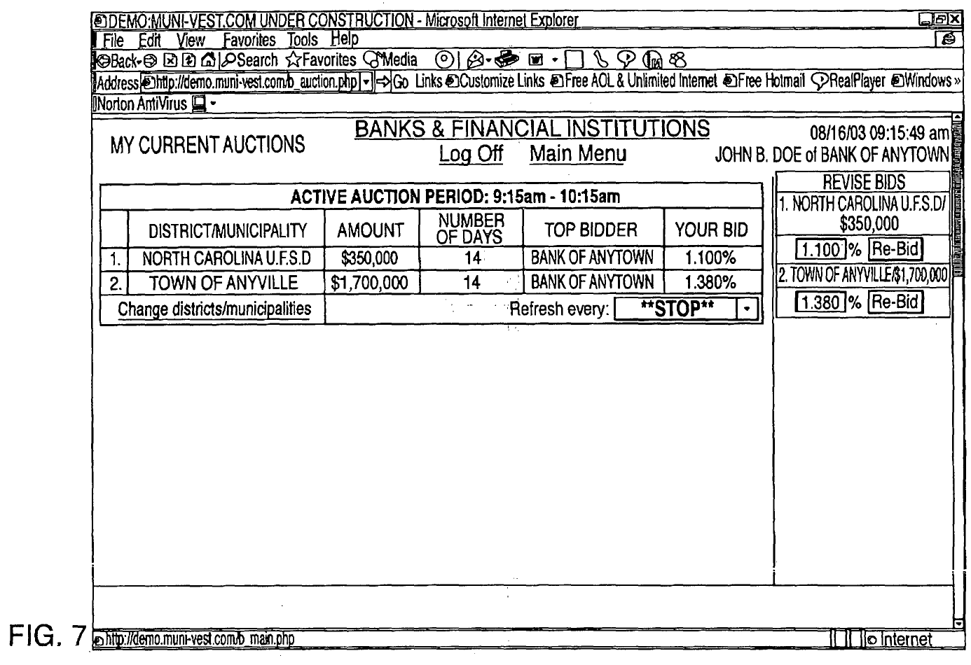

If the investee chooses to “go to auctions”, a screen such as that shown in FIG. 6 is displayed. The list in FIG. 6 indicates the current auction time period, e.g. 9:15 am to 10:15, and the names of the investors, i.e. auctions. A “show” checkbox is provided net to the name of each auction and a “show auctions” pushbutton is provided at the bottom of the list. After selecting the auctions of interest by checking the checkboxes, pressing the “show auctions” button will cause the details of each auction to be displayed in a new screen such as that shown in FIG. 7. In addition to showing the details of each investment, the screen of FIG. 7 allows the bidder to enter and update bids. Moreover, the screen indicates the name of the top bidder in each auction. The screen can be refreshed manually or set to refresh periodically. E.g., by clicking on the **STOP** menu, a drop down list of refresh times will be displayed.

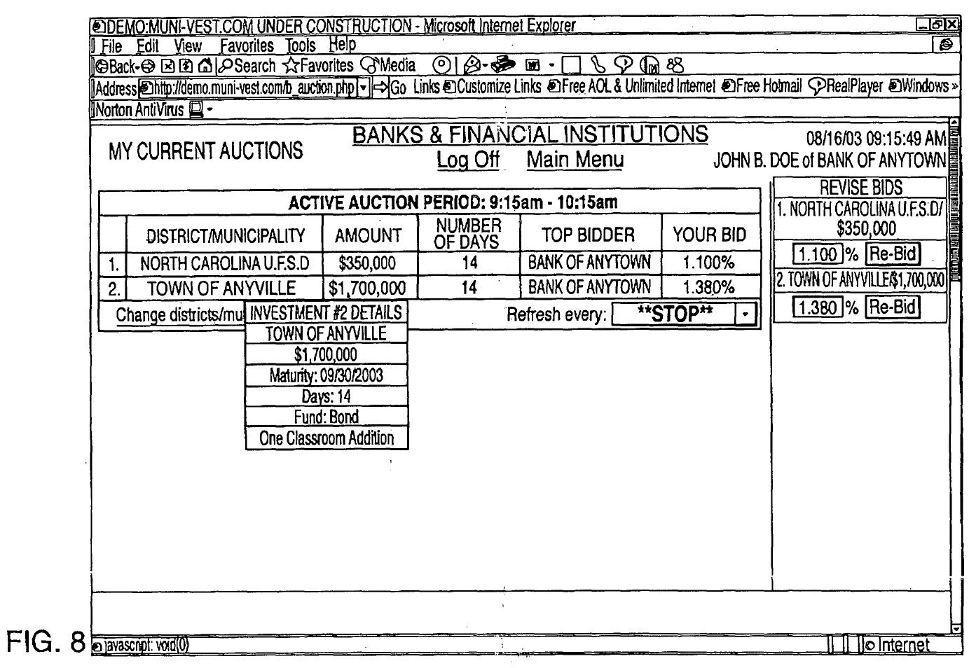

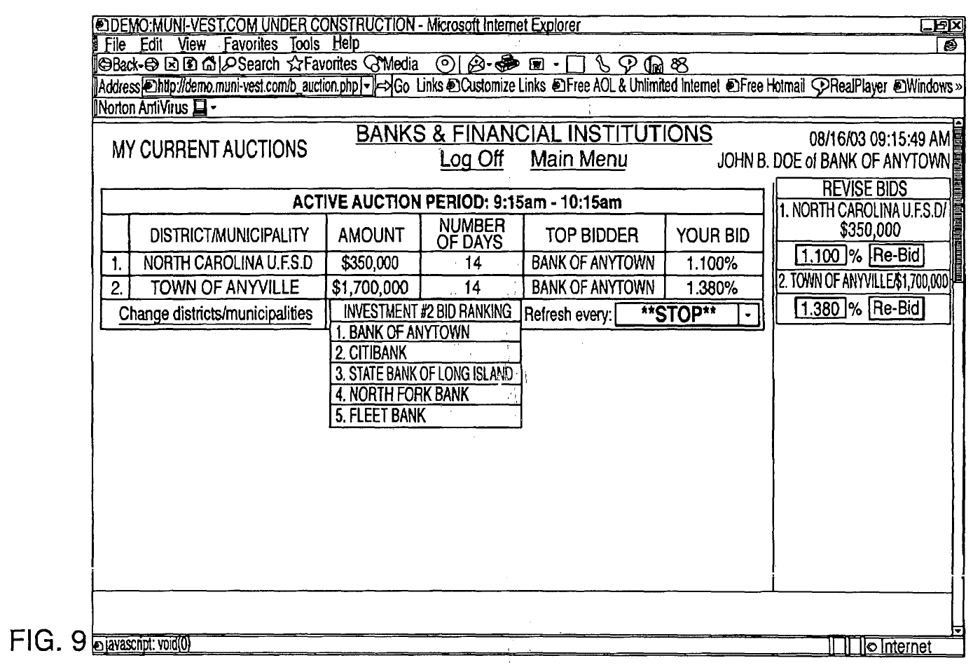

From the screen illustrated in FIG. 7, additional information can be obtained about the auctions and the top bidders by moving the cursor over the name of the auction or bidder. For example, as shown in FIG. 8, by moving the cursor over the name of the 2nd auction, additional information about that investment is displayed in a drop down box. By moving the cursor over the name of the top bidder, a ranking of bidders is displayed in a drop down box as shown in FIG. 9.

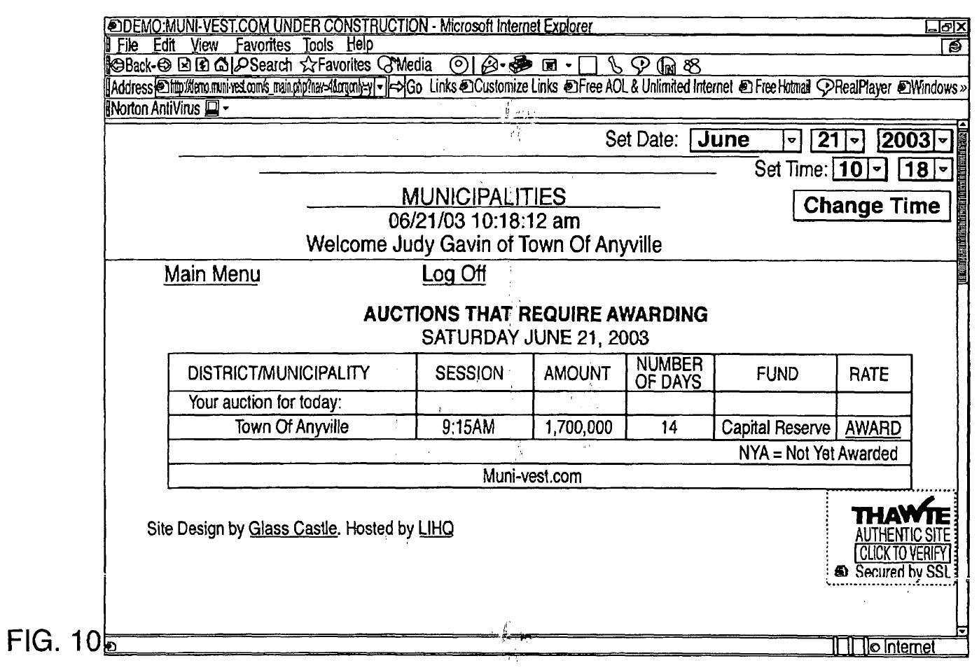

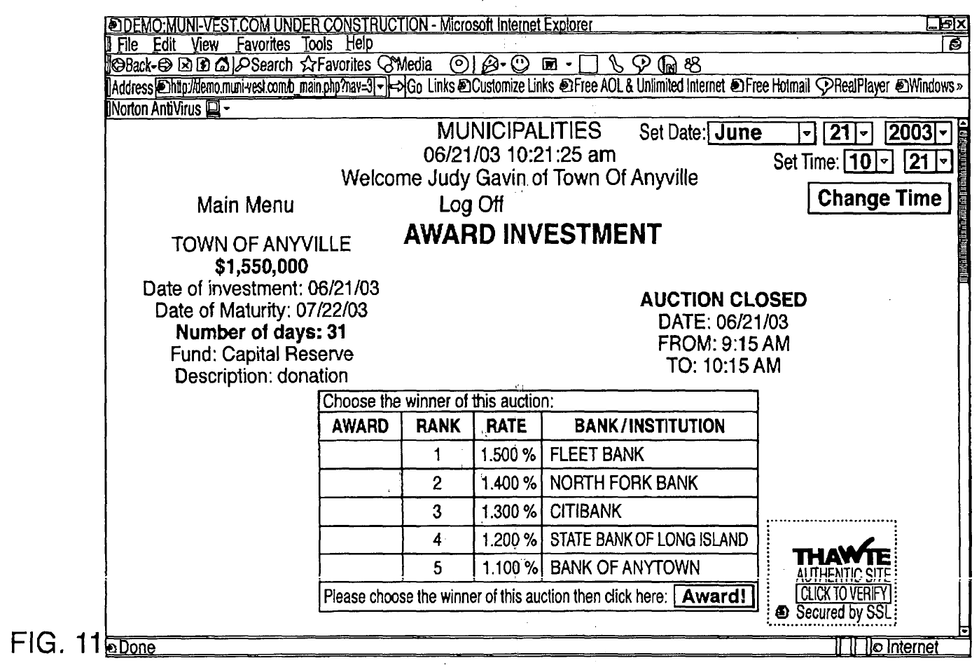

When the auctions are completed, the results are available for viewing by both the investors and the bidders. In addition, referring back to FIG. 1, investors can/must select “auctions that require awarding” from the main menu if the investor participated in a recent auction and received a bid. FIG. 10 illustrates a list of the investments for a particular investor for recent (today's) auctions). This screen may also be reached by selecting “award today's bids now” from an “all auctions have ended” screen which is automatically displayed when viewing the “live actions” screen. For each investment (auction), an “award” button is presented. Pressing the award button brings up the award screen, e.g. the screen shown in FIG. 11.

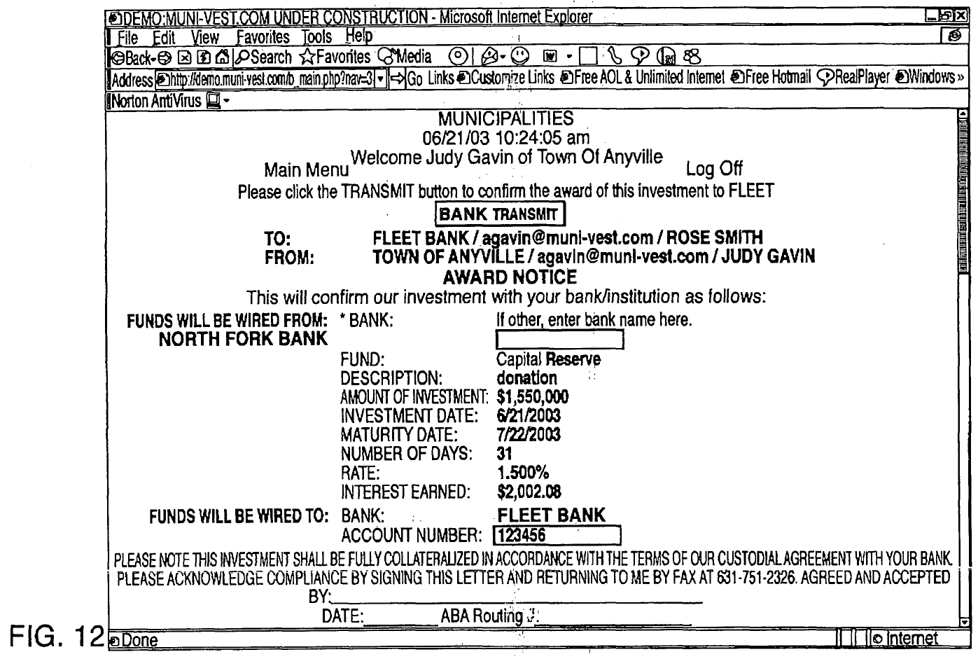

FIG. 11 shows an example of an “award investment” screen for a particular auction. Details of the investment and the auction date and time are presented followed by a grid listing all the bidders in rank order. The investor may select which bidder will be awarded the investment. Normally, this will be the number 1 bidder but the investor can award the bid to #2,3,4, etc. bidder or reject all the bids. In an alternate embodiment of the invention, no choice is given but to award the bid to the number 1 bidder. After selecting the bidder, the award pushbutton is pressed and the award notification screen, e.g. FIG. 12, is displayed.

FIG. 12 illustrates an example of an award notice screen. The screen includes the name of the investor, the name of the winning bidder, details of the investment and the bid. Most of the information on this screen is generated automatically. Two fields accept manual data entry. The first at the top of the screen is the name of the bank from which the funds will be transferred to the bidder, if other than the default bank. The other is the account number at the bidder where the funds will be received. This account number may be entered by the bidder after the award notice is received. This screen also includes a “transmit” pushbutton. When this button is pressed, an email simulating this screen is transmitted to the bidder. According to the methods of the invention, the bidder then prints the email, fills in the account number (if necessary), fills in the ABA routing number, signs and dates the document. The document is then faxed (or scanned emailed) back to the investor. Upon receipt of the signed document, the investor initiates the wire transfer.

There have been described and illustrated herein several embodiments of systems and methods whereby private and/or public organizations such as school districts and municipalities may maximize interest earnings on investments. While particular embodiments of the invention have been described, it is not intended that the invention be limited thereto, as it is intended that the invention be as broad in scope as the art will allow and that the specification be read likewise. For example, although the invention is especially intended for school districts and municipalities (e.g., villages, towns, water and fire districts, etc.), the invention is also applicable to other entities (e.g., colleges, corporations, non-profit corporations, etc.) who have relatively large cash assets to invest for a relatively short term. It will therefore be appreciated by those skilled in the art that yet other modifications could be made to the provided invention without deviating from its spirit and scope as so claimed.

1. A method for an investor to select and make an investment with an investee, said method comprising:
a) the investor advertising the amount and term of the investment;
b) a plurality of investees bidding for the advertised investment during a bidding period, the bidding including indicating a rate of return;
c) after the bidding period has ended, the investor selecting an investee based at least in part of the bids; and
d) the investor making the investment with the selected investee.

2. The method according to claim 1, further comprising:
e) after the bidding period has ended and prior to the investor selecting, automatically ranking bids according to rate of return.

3. The method according to claim 2, further comprising:
f) during the bidding period and prior to the investor selecting, automatically ranking bids according to rate of return.

4. The method according to claim 3, further comprising:
g) during the bidding period making the ranking knowable to all bidding investees.

5. The method according to claim 1, wherein:
said step of making the investment includes, in order, notifying the selected investee, receiving a signed acknowledgment from the selected investee, and transferring funds to the selected investee.

6. The method according to claim 1, wherein:
said steps of advertising and bidding are performed via an Internet web site.

7. The method according to claim 6, wherein:
said web site is a secure web site and investors and investees must register to participate.

8. A method for municipalities and school districts to select and make an investment with banks or financial institutions, said method comprising:
a) the municipalities and school districts advertising the amount and term of the investments they want to make;
b) the banks and financial institutions bidding for the advertised investments during a bidding period, the bidding including indicating a rate of return;
c) after the bidding period has ended, the municipalities and school districts selecting banks and financial institutions based at least in part on the bids; and
d) the municipalities and school districts making the investments with the selected banks and financial institutions.

9. The method according to claim 8, further comprising:
e) after the bidding period has ended and prior to the municipalities and school districts selecting, automatically ranking bids according to rate of return.

10. The method according to claim 9, further comprising:
f) during the bidding period has ended and prior to the municipalities and school districts selecting, automatically ranking bids according to rate of return.

11. The method according to claim 10, further comprising:
g) during the bidding period making the ranking knowable to all bidding banks and financial institutions.

12. The method according to claim 8, wherein:
said step of making the investments includes, in order, notifying the selected banks or financial institutions, receiving signed acknowledgments from the selected banks or financial institutions, and transferring funds to the selected banks or financial institutions.

13. The method according to claim 8, wherein:
said steps of advertising and bidding are performed via an Internet web site.

14. The method according to claim 13, wherein:
said web site is a secure web site and municipalities, school districts, banks and financial institutions must register to participate.

15. A method for municipalities and school districts to select and make investments with banks or financial institutions via the Internet, said method comprising:
a) the municipalities and school districts advertising the amount and term of the investments they want to make on a secure web site;
b) the banks and financial institutions bidding for the advertised investments on the web site during a bidding period, the bidding including indicating a rate of return;
c) after the bidding period has ended, the municipalities and school districts selecting, via the web site, banks and financial institutions based at least in part on the bids; and
d) the municipalities and school districts making the investments with the selected banks and financial institutions.

16. The method according to claim 15, further comprising:
e) after the bidding period has ended and prior to the municipalities and school districts selecting, automatically ranking bids according to rate of return.

17. The method according to claim 16, further comprising:
f) during the bidding period and prior to the municipalities and school districts selecting, automatically ranking bids according to rate of return.

18. The method according to claim 17, further comprising:
g) during the bidding period making the ranking knowable to all bidding banks and financial institutions via the web site.

19. The method according to claim 15, wherein:
said step of making the investment includes, in order, notifying the selected bank or financial institution via email, receiving a signed acknowledgment from the selected bank or financial institution via fax or email, and transferring funds to the selected bank or financial institution by wire transfer.

20. A system for an investor to select and make an investment with an investee, said system comprising:
a secure server coupled to the Internet, said secure server including
a) means for receiving investment information from the investor, said investment information including the amount and term of the investment;
b) means for advertising at least some of the investment information via the Internet;
c) means for accepting bids for the advertised investment from investees vis the Internet during a bidding period, the bids including a rate of return; and
d) means for displaying the bids via the Internet to the investor.

21. The system according to claim 20, said secure server further including:
e) means for receiving a bid selection from the investor via the Internet; and
f) means for notifying the investee via the Internet of the bid selection.

22. The system according to claim 21, said secure server further including:
g) means for automatically ranking bids according to rate of return.

23. The system according to claim 22, said secure server further including:
h) means for making the ranking knowable via the Internet to all bidding investees during the bidding period.
